(19) United States
(12) Patent Application Publication
(10) Pub. No.: US 2012/0038744 A1
(43) Pub. Date: Feb. 16, 2012

(54) AUTOMATIC 3D CONTENT DETECTION

(76) Inventor: Masafumi Naka, Irvine, CA (US)

(21) Appl. No.: 13/171,827

(22) Filed: Jun. 29, 2011

Related U.S. Application Data
(60) Provisional application No. 61/373,710, filed on Aug. 13, 2010.

(51) Int. Cl. H04N 13/00; H04N 3/27

(52) U.S. Cl. 348/43; 348/554; 348/E13.001; 348/E03.049

(57) ABSTRACT

Improved systems and methods that facilitate automatic detection of 3D content in a video program signals and, based on the detection of 3D content, automatically switches as the program signal processing and display mode of the television to 3D format. A 3D detection module parses frames of an input video program signal into first and second images and determines the level of correlation between the images by motion vector and histogram information from the images.

### CROSS-REFERENCE TO RELATED APPLICATION

This application claims priority to Provisional Application Ser. No. 61/373,710 filed Aug. 13, 2010, which is fully incorporated herein by reference.

### FIELD

The subject matter described herein relates generally to three-dimensional (3D) video display and, more particularly, to systems and methods to automatically detect 3D content in a video program signal and switch to 3D format video signal processing and display.

### BACKGROUND

Three-dimensional (3D) video display is done by presenting separate images to each of the viewer's eyes. One example of a 3D video display implementation in television, referred to as time-multiplexed 3D display technology using shutter glasses. In time-multiplexed 3D display implementation, different images are sent to the viewer's right and left eyes. Images within a video signal are coded as right and left pairs of images, which are decoded separately by the television for display. The images are staggered in time with the right image being rendered on the display screen of the television followed by the left image being rendered on the display screen of the television. The television typically provides a synchronization signal to a pair of LCD shutter glasses worn by the viewer(s). The shutter glasses include left and right shutter lenses. The shutter glasses selectively block and pass the light in coordination with the synchronization signal. Thus the viewer's right eye only sees the right image rendered on the screen, and the left eye only sees the left image rendered on the screen. From the information received from the two eyes, and the difference between them, the viewer's brain reconstructs a 3D representation of the object being shown.

In order for a 3D video program to be properly displayed by the television the viewer must manually place the television in 3D processing and display mode by navigating the television setup menus. If the viewer forgets how to or is unable to navigate the television's setup menus, the 3D video program signal will not be properly processed and displayed by the television.

Therefore, it would be desirable to provide systems and methods that facilitate automatic detection of 3D content in a video program signal and, based on the detection of 3D content, automatically switching the display mode of the television to 3D video display.

### SUMMARY

Embodiments described herein are directed to improved systems and methods that facilitate automatic detection of 3D content in a video program signal and, based on the detection of 3D content, automatic switching of the program signal processing and display mode of the television to 3D format. In a preferred embodiment, a television configured to enable automatic 3D video content detection and viewing includes a control system comprising a central processing unit (CPU) and on screen display (OSD) controller coupled to the CPU for processing and displaying the program signal in the proper format such as standard video or 3D fast format. The CPU preferably comprises non-volatile memory coupled to a logic unit which includes integrated circuits, processors, and software stored in memory and executable on the processors, and a 3D detection module configured to detect whether an input video program signal Sₚ contains 3D video content. Depending on the determination of the 3D detection module, the logic unit will automatically instructs the OSD controller to process and display the program signal Sₚ in standard or 3D format. The 3D detection module, which preferably comprises a signal parser, motion vector and histogram detectors and comparators, and a correlation detector, parses frames of an input video program signal Sₚ into first and second images and determines the level of correlation between the first and second images by motion vector and histogram information from the images. If the input signal is interlace, the detection can be done on either a frame-by-frame or a field-by-field basis.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic diagram of a television system.

FIG. 2 is a schematic diagram of a 3D detection module.

FIG. 3 is a chart showing the Histogram of the left and right images of a video program signal frame.

FIG. 4 is a diagram showing the motion vectors of the left and right images of successive video program signal frames.

FIG. 5 is a chart illustrating 3D detection threshold setting.

FIG. 6 is a chart illustrating 3D detection threshold setting.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Embodiments, described herein are directed to improved methods and systems that facilitate automatic detection of 3D content in a video program signal and, based on the detection of 3D content, automatically switching the processing and display mode of the television to 3D format. The left and right images (or top and bottom images) of a video program signal in 3D format, which are created by two cameras for left and right eye viewing (or by computer graphics), are very similar except for the camera angle from which imaged object is shot. Thus, the level of correlation between the left and right images can be used to detect whether the video program signal Sₚ is in 3D format.

In a preferred embodiment, frames of an input video program signal Sₚ are parsed into first and second images, such as left and right images, top and bottom images, or the like, and the correlation of the first and second images are determined by motion vector information and histogram information. If, based on the level of correlation between the first and second images, it is determined that the video program signal includes 3D content, the television automatically switches the video processing and display mode to 3D format without the need for viewer or user input.

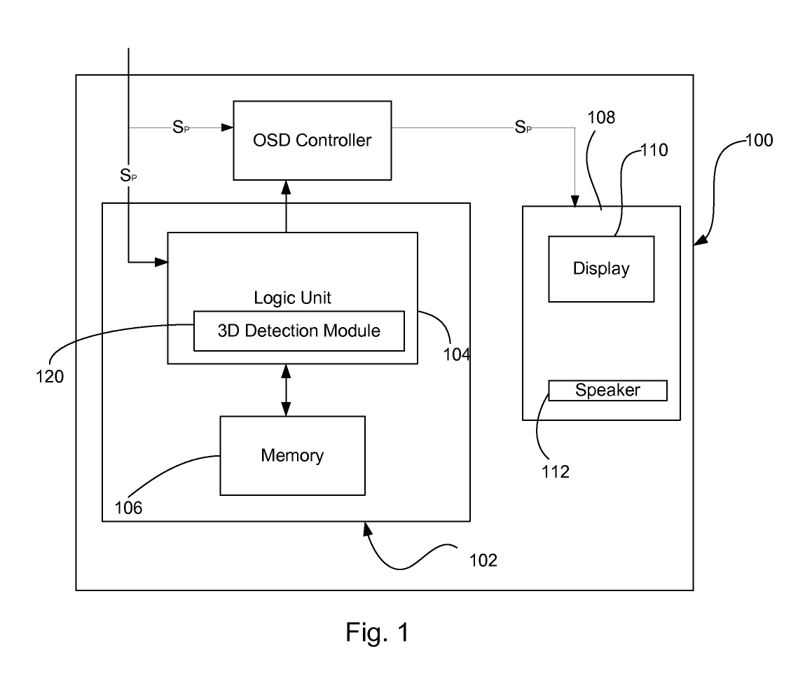

Turning to figures, the embodiments provided herein are described in detail. In a preferred embodiment, as depicted in FIG. 1, a television 100 configured to enable automatic 3D video content detection and 3D video processing and display includes a control system comprising a central processing unit (CPU) 102 and an on screen display (OSD) controller 104. The OSD controller 104 controls the format in which a program signal is processed and displayed. The television further includes an audio-video output unit 110 coupled to the OSD controller 104. The audio-video output unit 110 preferably includes a video display 112 for displaying the images or video component of a program signal Sₚ and a speaker 114 for outputting the audio program signal Sₚ or the audio component of the program signal Sₚ associated with the video component of program signal Sₚ.

The CPU 102 preferably comprises non-volatile memory 106 coupled to a logic unit 108 which includes integrated circuits, processors, and software stored in memory 106 and executable on the processors. The logic unit 108 includes a 3D detection module 120 configured to detect whether an input video program signal Sₚ contains 3D video content. Depending on the determination of the 3D detection module 120, the logic unit 108 will automatically instruct the OSD controller 104 to process and display the program signal Sₚ in standard or 3D format. If instructed to process and display the program signal Sₚ in 3D format, the OSD controller 104 will separately decode right and left pairs of images (or top and bottom pairs of images) within the input video program signal Sₚ and display the images on the video display 112 in a manner readily understood by one of skill in the art.

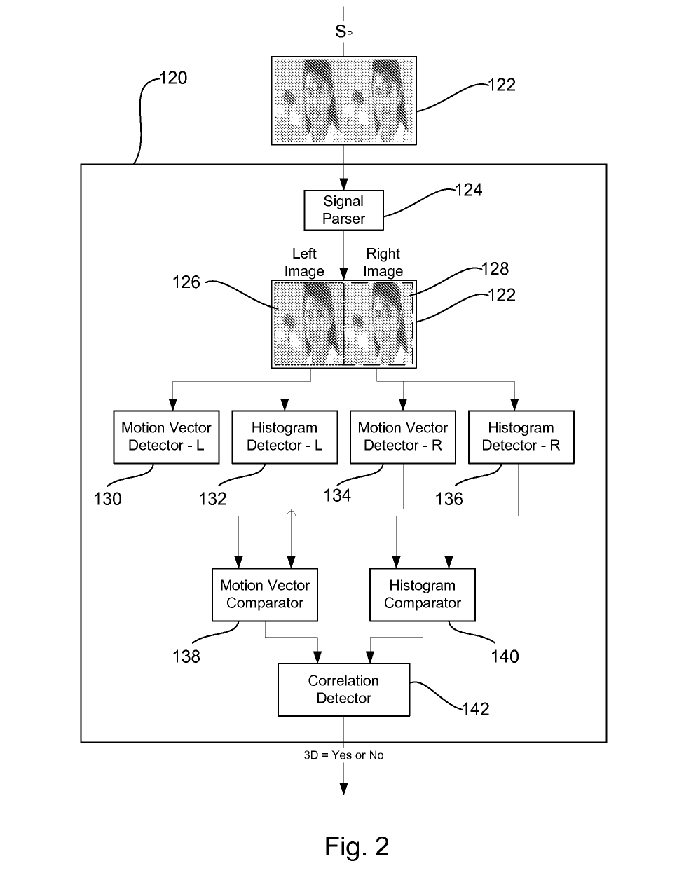

Turning to FIG. 2, the 3D detection module 120 includes a signal parser 124 which parses the frames 122 of an input video program signal Sₚ into a left image 126 and a right image 128 to be analyzed to determine the level of correlation between the left and right images 126 and 128 of the video frame 122. The left and right images 126 and 128 output from the parser 124 are fed into left and right motion vector detectors 130 and 134 to retrieve motion vector information from the left and right images 126 and 128. If the input signal Sₚ is interlace, the detection and comparison can be done on either a frame-by-frame or field-by-field basis.

An example of motion vector information detected by the left and right image motion vector detectors 130 and 134 is illustrated in FIG. 4. A motion vector comparator 138 compares the motion vector output received from the left and right image motion vector detectors 130 and 134. The motion vector comparator 138 compares each point of vector data between the left and right images 126 and 128. If a first vector 150 of the left image 126 is within a certain range or threshold value of a first vector 152 of the right image 128, i.e., the angle and distances of the vectors 150 and 152 are within a certain range or threshold value of one another, then the first vectors 150 and 152 of the left and right images 126 and 128 are considered to be equal vectors.

Motion vector detection and comparison does not work, however, when the frame comprises a freeze frame or still image.

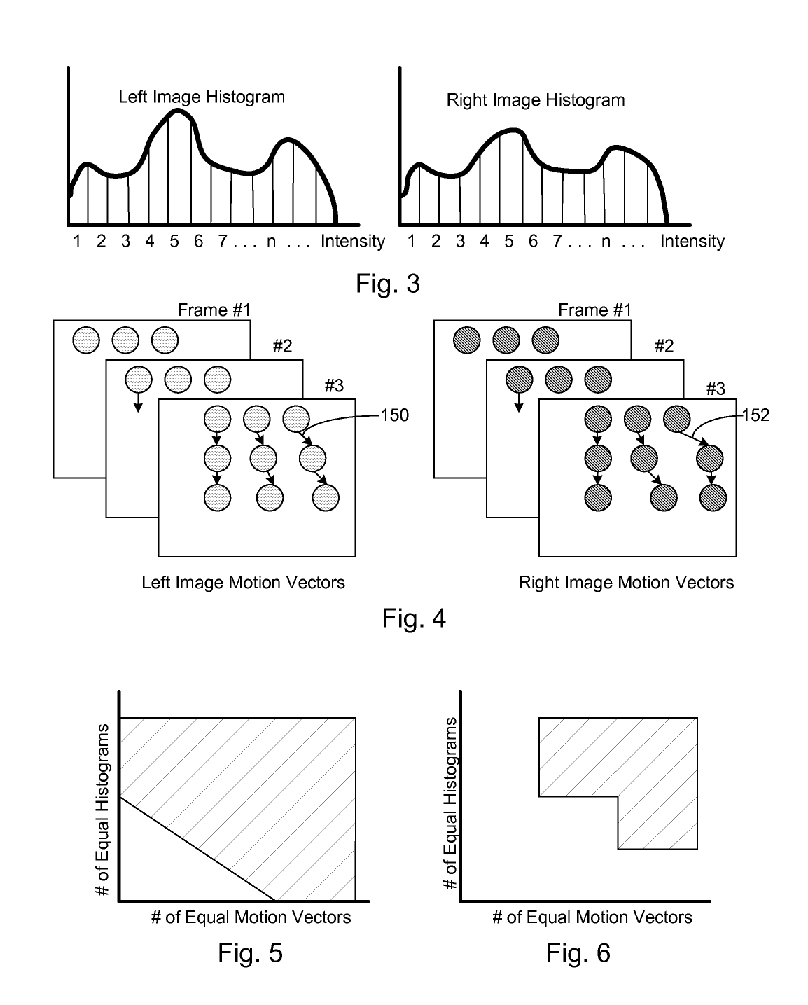

Similarly, the left and right images 126 and 128 are fed into left and right histogram detectors 132 and 134 to retrieve histogram information from the left and right images 126 and 128. An example of histogram information detected by the left and right image histogram detectors 130 and 134 is illustrated in FIG. 3. The histogram information can be, e.g., luminance and/or color within the intensity domain.

A histogram comparator 140 compares the histogram output received from the left and right histogram detectors 132 and 134 for each segment of the left and right images 126 and 128 in, e.g., the intensity domain. The histogram comparator 140 compares a ratio of histogram data between segments 1, 2, 3, . . . , n of the left and right images 126 and 128. If the ratio between corresponding segments of the left and right images is within a certain range or threshold value, the corresponding segments of the left and right images 126 and 128 are considered to be equal.

A correlation detector 142 uses the information output from the motion vector comparator 138 and the histogram comparator 140 to determine if the content of the program signal Sₚ is in 3D format or not. The correlation detector 142 evaluates the number of equal vectors and equal segments of the left and right images 126 and 128 and if the number of equal vectors and/or equal segments are above a threshold number of equal vectors and/or equal segments, the content of the program signal Sₚ is considered to be in 3D format.

FIGS. 5 and 6 provide examples of evaluation thresholds for 3D format detection. FIG. 5 illustrates a “wide” detection threshold wherein if a threshold for either the number of equal vectors or equal segments is reached, the content of the program signal Sₚ is considered to be in 3D format regardless of the corresponding number of equal vectors or equal segments. FIG. 6, however, illustrates a more “conservative” detection threshold in which a threshold number of equal vectors and equal segments must both be reached in order for the program signal Sₚ to be considered to be in 3D format.

If the correlation detector 142 determines the content of the program signal Sₚ to be in 3D format, the logic unit 102 automatically instructs the OSD controller 104 to process and display the program signal Sₚ in 3D format.

The particular examples set forth herein are instructional and should not be interpreted as limitations on the applications to which those of ordinary skill are able to apply the systems and methods described herein. Modifications and other uses are available to those skilled in the art which are encompassed within the spirit of the invention as defined by the scope of the appended claims.

What is claimed is:

1. A method of detecting 3D content in a program signal and switching program signal procession and display mode to 3D formation in a television, comprising the steps of
parsing a frame of a program signal into first and second images,
determining the level of correlation between the first and second images,
setting the program signal processing mode as a function of the level of correlation between the first and second images.

2. The method of claim 1 wherein the step of determining the level of correlation includes detecting the motion vectors of each of the first and second images.

3. The method of claim 2 wherein the step of determining the level of correlation includes comparing the motion vectors of the first image with corresponding motion vectors of the second image to determine if the vectors are equal.

4. The method of claim 3 wherein the step of comparing the motion vectors of the first and second images includes comparing the angle and distance of the vectors.

5. The method of claim 4 wherein the step of comparing the angle and distance of the vectors includes determining whether the angle and distance values of the vectors are within a threshold value of one another to determine if the vectors are equal.

6. The method of claim 3 wherein the step of determining the level of correlation includes comparing the histograms of the first and second images.

7. The method of claim 6 wherein the step of comparing the histograms of the first and second images includes comparing a ratio of histogram data between the left and right images for N segments of the images.

8. The method of claim 7 wherein the step of a ratio of histogram data between the left and right images for N segments of the images includes determining whether the ratio of histogram data for corresponding segments is within a threshold value to determine if the segments are equal.

9. The method of claim 6 wherein the step of determining the level of correlation includes determining whether the number of equal vectors and equal segments of the first and second images is above a threshold number of equal vectors and/or equal segments.

10. A television comprising
a display screen,
an on screen display (OSD) controller coupled to the display screen, and
a central processing unit coupled to the OSD controller, the central processing unit being configured to parse a frame of an input program signal into first and second images, determine the level of correlation between the first and second images, and instruct the OSD controller to process and display the program signal in a particular processing and display format as a function of the level of correlation between the first and second images.

11. The television of claim 10 wherein the central procession unit includes a logic unit comprising a 3D content detection module.

12. The television of claim 11 wherein the 3D content detection module comprises a program signal parser.

13. The television of claim 12 wherein the 3D content detection module further comprises first and second motion vector detectors that receive the output from the signal parser.

14. The television of claim 13 wherein the 3D content detection module further comprises first and second histogram detectors that receive the output from the signal parser.

15. The television of claim 14 wherein the 3D content detection module further comprises a motion vector comparator that receives the outputs from the first and second motion vector detectors.

16. The television of claim 15 wherein the 3D content detection module further comprises a histogram comparator that receives the outputs from the first and second histogram detectors.

17. The television of claim 17 wherein the 3D content detection module further comprises a correlation detector that receives the outputs from the motion vector and histogram comparators.
